(19) United States
(12) Patent Application Publication
(10) Pub. No.: US 2024/0274974 A1
(43) Pub. Date: Aug. 15, 2024

(54) BATTERY PACK WITH RECHARGEABLE REACTION SUPPRESSION SYSTEM

(71) Applicant: Dana Automotive Systems Group, LLC, Maumee, OH (US)

(72) Inventor: Louisa OUALIM, Royal Oak, MI (US)

(21) Appl. No.: 18/437,788

(22) Filed: Feb. 9, 2024

Related U.S. Application Data
(60) Provisional application No. 63/484,642, filed on Feb. 13, 2023.

(51) Int. Cl. H01M 50/383; H01M 10/48; H01M 50/204; H01M 50/249

(52) U.S. Cl. CPC H01M 50/383; H01M 10/486; H01M 50/204; H01M 50/249; H01M 2200/10; H01M 2200/20; H01M 2220/20

(57) ABSTRACT

Methods and systems are provided for a battery system for a vehicle which comprises a plurality of battery cells housed inside an enclosure of a battery pack and a rechargeable reaction suppression system. In one example, the rechargeable reaction suppression system comprises an on-board reaction suppress system and a recharge system. The on-board reaction suppression system includes a first housing, an outlet pipe, and a first valve, a first charge of suppressing agent housed in the first housing. The recharge system comprises a second housing and a piping, a second charge of suppression agent housed in the second housing. Coordinated actuation of the first and second valves in response to sensor data during a thermal event discharges the first charge, recharges the system, and discharges the second charge to slow an exothermic reaction and mitigate subsequent thermal events.

### CROSS REFERENCE TO RELATED APPLICATIONS

The present application claims priority to U.S. Provisional Application No. 63/484,642 entitled “BATTERY PACK WITH RECHARGEABLE REACTION SUPPRESSION SYSTEM”, filed Feb. 13, 2023. The entire contents of the above-listed application is hereby incorporated by reference for all purposes.

### TECHNICAL FIELD

The present description relates generally to a reaction suppression system, more specifically a battery pack of a rechargeable electric vehicle comprising a reaction suppression system.

### BACKGROUND AND SUMMARY

A battery assembly, including a battery, may be installed in an automotive vehicle for assisting engine start and powering other vehicle systems. The battery may be enclosed in a cover to shield the battery from contact with external objects, provide a thermal barrier to inhibit heat conduction from the battery to surrounding components, and maintain the position of the battery relative to the vehicle. The battery enclosure thus provides a barrier between the battery and other objects and reduces a likelihood of combustion arising from overheating or puncture. Rechargeable battery packs, such as lithium-ion battery packs, are widely used in electric vehicles to supply one or more electric motor(s) with power. Lithium-ion batteries are an example of high energy density batteries. Upon charging and discharging of such a battery pack, heat may be generated inside battery cells of the battery pack thereby affecting temperature of the pack.

In some examples, such as an electric vehicle or a hybrid electric vehicle operating in all-electric mode, propulsion and operation of other vehicle systems exclusively relies on electric power. In order to improve battery performance, battery temperature control may be provided by a thermal management system. Battery cells within an enclosure of a battery pack are prone to exothermic reactions caused by shorts or faults within the cell that lead to high pressure and temperature events which may cause degradation of the battery cell, the enclosure, and the battery pack. In some instances, an initial exothermic reaction may be initially extinguished by the thermal management system, but may later react again either in the same cell as the initial reaction or in another battery cell. In addition to providing battery packs with such thermal management systems, various systems may be provided to remove or limit oxidants around the battery cells to reduce possibility of additional exothermic reactions that can further increase temperature and/or battery degradation.

However, the inventors herein have recognized potential issues with thermal management systems. As one example, the risk of degradation remains in thermal management systems that employ only a cooling system or a venting strategy but fail to reduce oxidants within the enclosure produced by exothermic reactions. A mechanism is needed to rapidly discharge a suppressing agent inside the pack and to recharge the suppressing agent for additional discharges in order to slow an exothermic reaction from causing further degradation to the battery.

The inventors herein have recognized the aforementioned challenges and developed a reaction suppression system to at least partially address these challenges. In one example, a battery pack is disclosed that includes a rechargeable reaction suppression system. The rechargeable reaction suppression system includes an on-board reaction suppression system housing a first charge of a suppressing agent and portions of a recharge system housed external to the vehicle housing a second charge of the suppressing agent. The rechargeable reaction suppression system is configured to dispense the first charge from a first housing of the on-board reaction suppression system into an enclosure of the battery pack. In a first embodiment, the system is recharged by deploying the second charge into the first housing of the on-board reaction suppression system and then discharge the second charge into the enclosure of the battery pack. In a second embodiment, the second charge is deployed into a manifold of the on-board reaction suppression system and then discharged into the enclosure. In a third embodiment, the second charge is deployed into the enclosure, bypassing the on-board reaction suppression system. The reaction suppression system includes a plurality of valves controlled by a control system that comprises one or more actuators and one or more sensors. Coordinated actuation of the valves is executed in response to sensor data indicating conditions of the enclosure, the on-board reaction suppression system, and/or the recharge system. The plurality of valves open and/or close in response to sensor data indicating conditions such as pressure or partial pressure of the suppressing agent.

Recharging of the reaction suppression system allows for additional discharges of the suppressing agent to be delivered into the battery pack, providing increased mitigation of future thermal events therein. Mitigation of future thermal events decreases degradation to the battery pack as well as to the electric vehicle as a whole, providing for increased longevity even in the event of an exothermic reaction. Further, additional charges of the suppressing agent increases reduction of oxidants within the enclosure by increasing the amount of suppressing agent that is dispersed throughout the enclosure. With reduced oxidants within the enclosure, subsequent exothermic reactions and/or thermal events are further mitigated.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 shows an example of an at least partially electrified vehicle;

FIG. 2 shows a perspective view of an example battery pack with an on-board reaction suppression system;

FIG. 3A shows an example of a rechargeable reaction suppression system in accordance with an embodiment of the present disclosure;

FIG. 3B shows the rechargeable reaction suppression system in accordance with a second embodiment of the present disclosure;

FIG. 3C shows the rechargeable reaction suppression system in accordance with a third embodiment of the present disclosure;

FIG. 4 is a flowchart illustrating an example method for operating the rechargeable reaction suppression system in accordance with the first or a second embodiment of the present disclosure;

FIG. 5 is a flowchart illustrating another example method for operating the rechargeable reaction suppression system in accordance with the first embodiment of the present disclosure; and

FIG. 6 shows timing diagrams of a use-case scenario for the rechargeable reaction suppression system in accordance with the first embodiment of the present disclosure.

### DETAILED DESCRIPTION

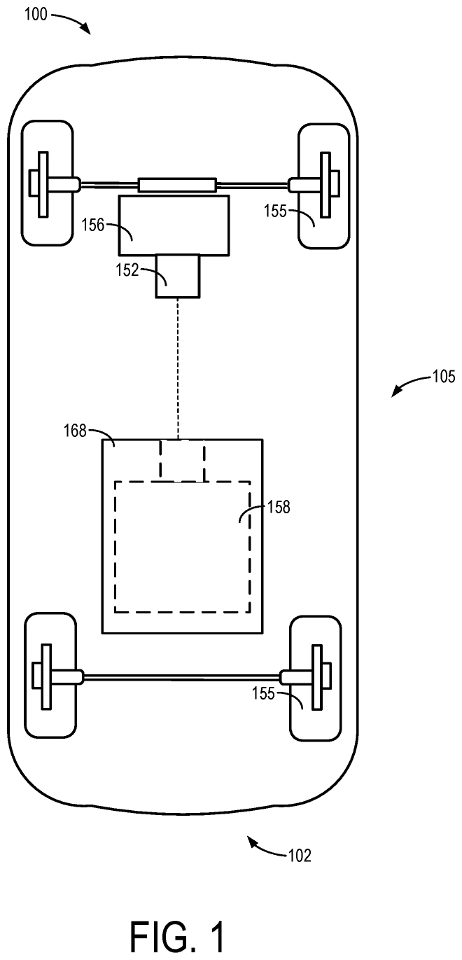

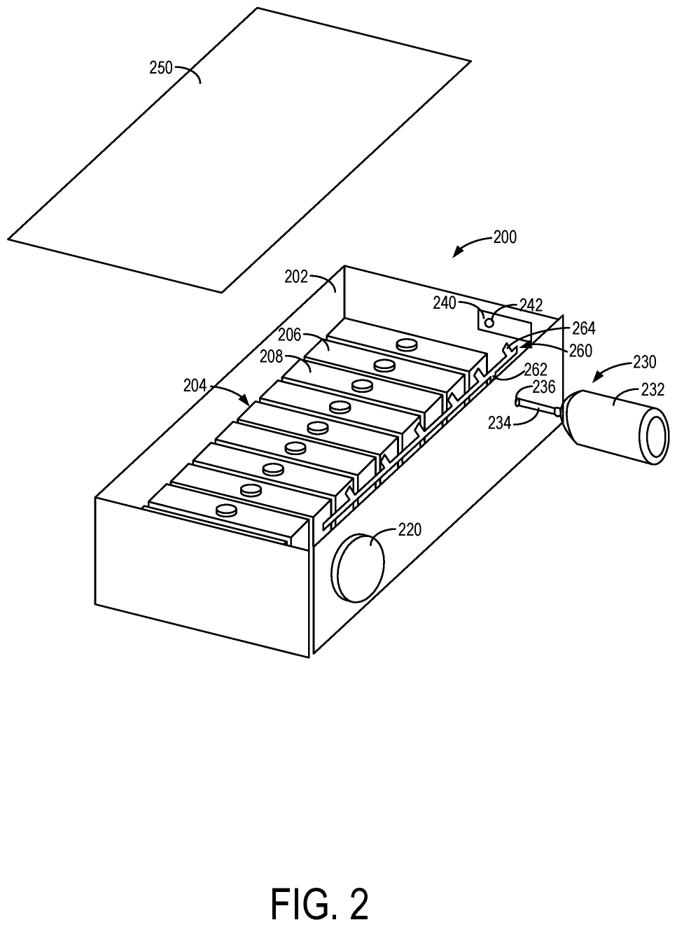

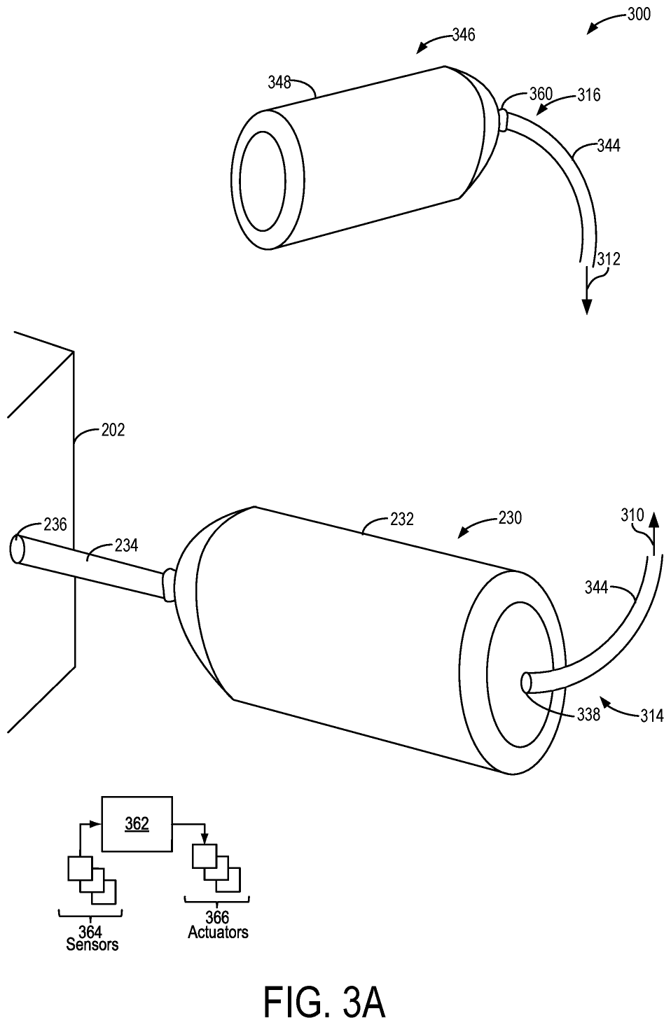

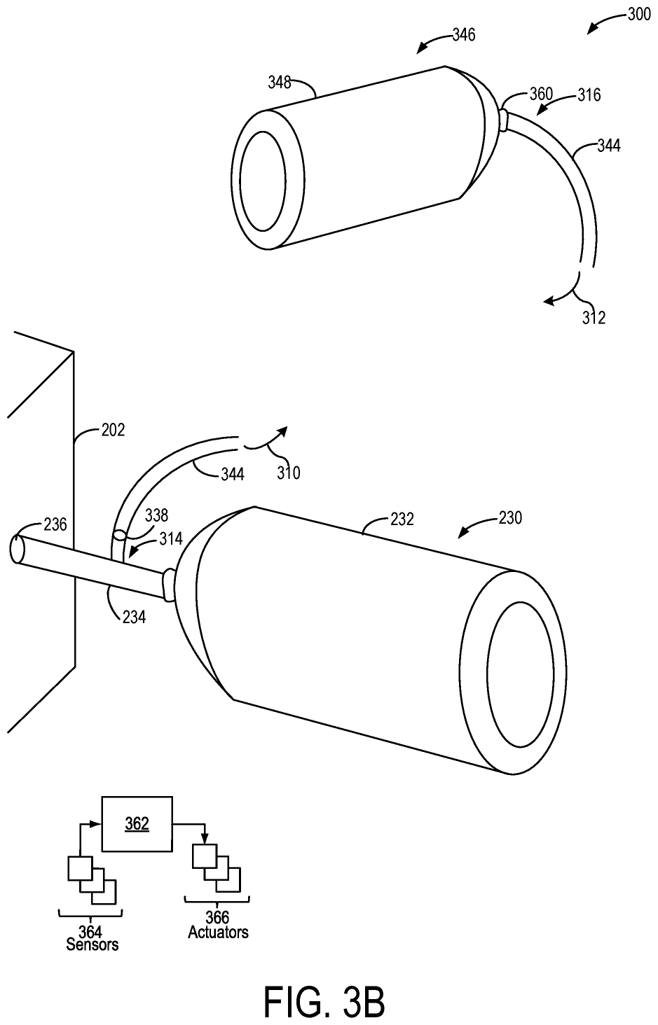

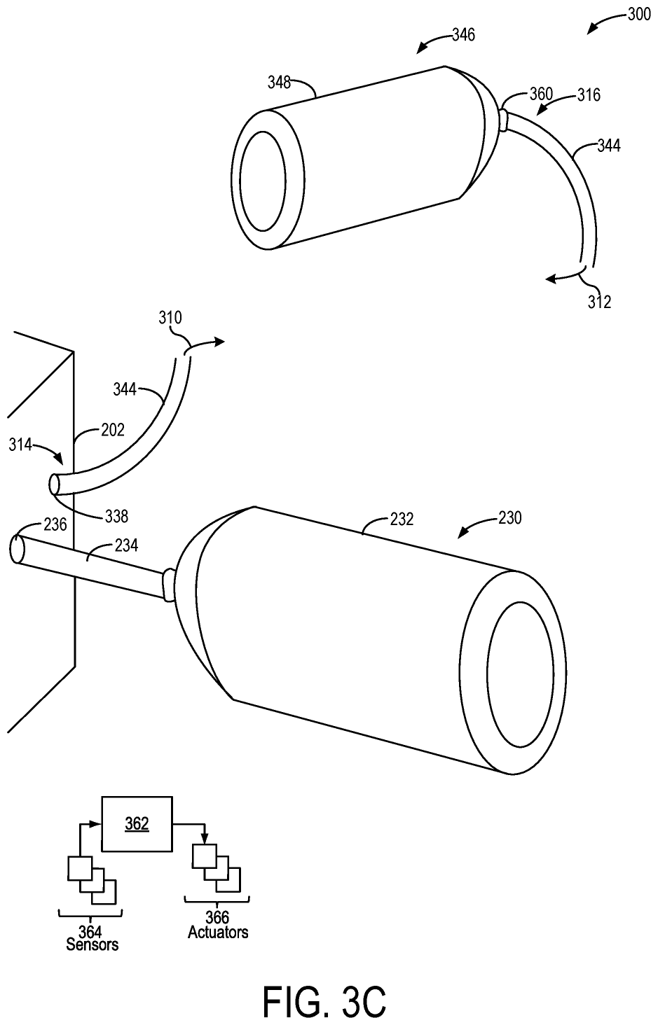

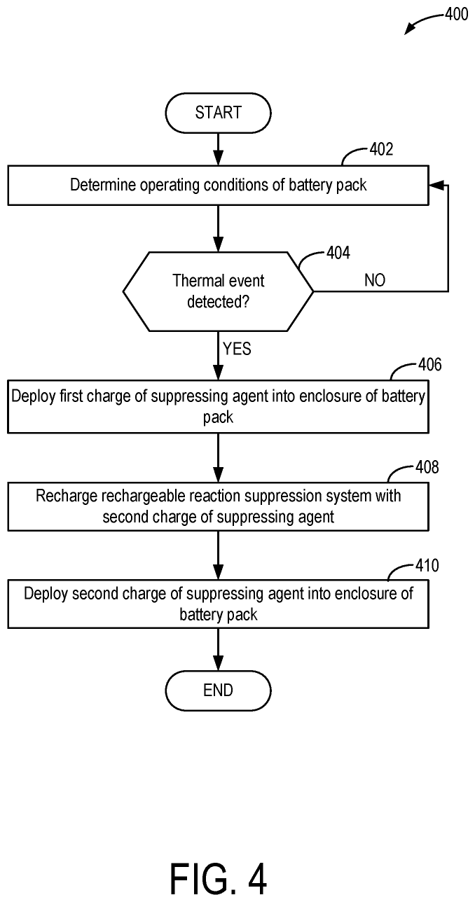

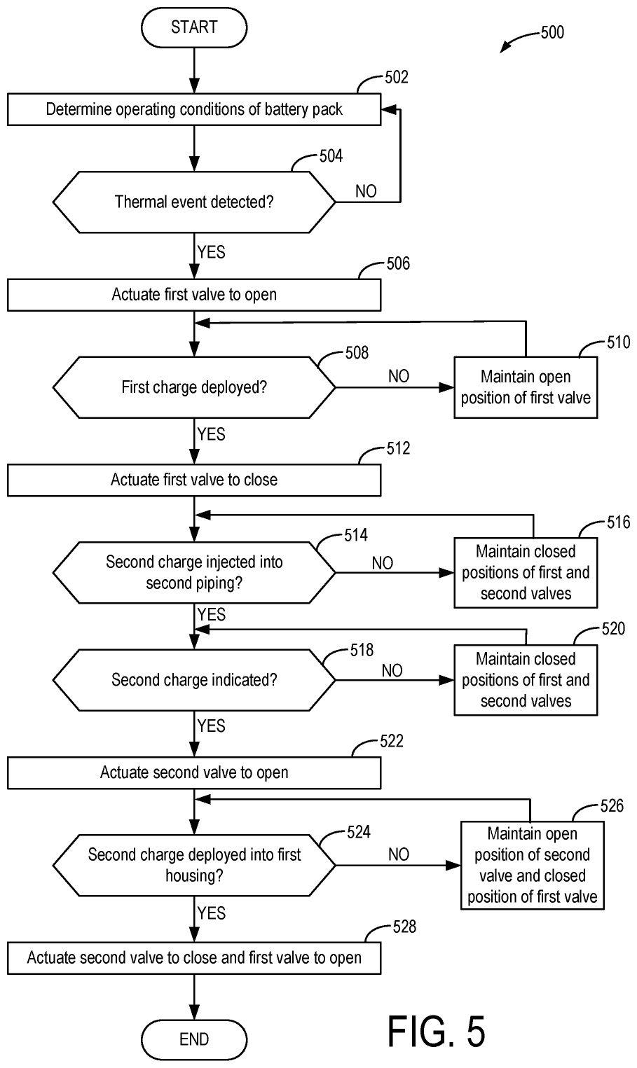

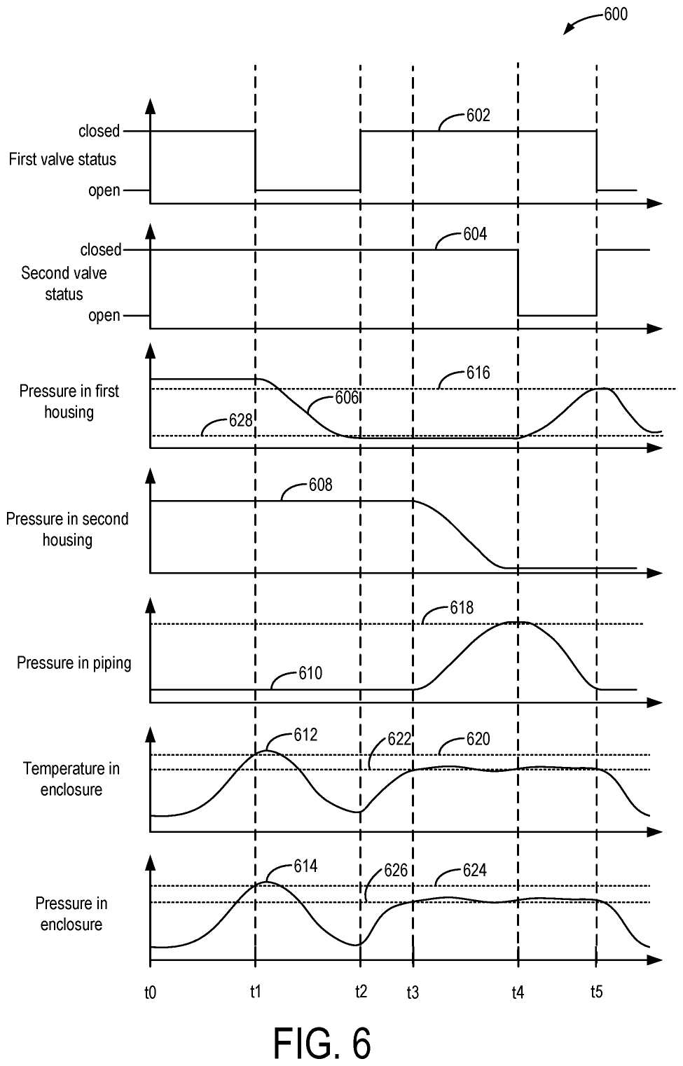

The following description relates to systems and methods for a battery system of an electric vehicle with a rechargeable reaction suppression system including at least two charges of a suppressing agent. An example of a vehicle configured with an electrified vehicle drive train system, including a battery housed in an enclosure, is shown in FIG. 1. The battery system may comprise at least one battery pack. Each battery pack may comprise an enclosure housing a plurality of battery cells, a monitoring system, a venting system, and an on-board reaction suppressing system, as shown in FIG. 2. The rechargeable reaction suppression system may comprise the on-board reaction suppression system, a recharge system, and a control system, as shown in FIGS. 3A-3C. The on-board reaction suppression system may comprise a first housing, a manifold, a first valve, and, in some examples, a second valve. The recharge system may comprise a piping and a second housing. A method for reaction suppression in response to a thermal event is shown in FIG. 4. A method for operation of the rechargeable reaction suppression system is shown in FIG. 5. A use-case operating sequence for the rechargeable reaction suppression system is depicted in FIG. 6.

In one example, the disclosure provides support for a battery system including a battery pack with a rechargeable reaction suppression system and a suppressing agent. The reaction suppression system may include at least two housings for the suppressing agent and a plurality of valves. The plurality of valves may be actuated to open and/or close in response to sensor data indicating conditions such as pressure or partial pressure of the suppressing agent within one of the at least two housings or a tubing.

A first housing of the at least two housings may be positioned external to or within the enclosure and a first charge of the suppressing agent may be discharged into the enclosure from the first housing via a manifold during a thermal event in which temperature and/or pressure rises within the enclosure. A second housing of the at least two housings may be stored external to the vehicle and a second charge of the suppressing agent may be deployed from the second housing. In a first embodiment, the second charge is deployed into the first housing of the on-board reaction suppression system, refilling the first housing, and may then be deployed from the first housing into the enclosure. In a second embodiment, the second charge is deployed into the manifold of the on-board reaction suppression system. In a third embodiment, the second charge is deployed directly into the enclosure, bypassing the on-board reaction suppression system. Discharge of the second charge to recharge the rechargeable reaction suppression system occurs following discharge of the first charge of the suppressing agent from the first housing. With the additional charge of the suppressing agent, degradation to the battery pack and/or the electric vehicle may be reduced by slowing an initial exothermic reaction that caused the thermal event as well as mitigating potential subsequent exothermic reactions and/or thermal events by reducing oxidants in the enclosure.

FIGS. 1-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, an example vehicle 105 is shown. In some examples, vehicle 105 may be a hybrid vehicle with multiple sources of torque available to one or more vehicle wheels 155. In other examples, vehicle 105 may be an all-electric vehicle, powered exclusively by an energy storage device such as a battery assembly, herein referred to as a battery 158. In the example shown, vehicle 105 includes an electric machine 152 which may be a motor or a motor/generator. Electric machine 152 receives electrical power from the battery 158 which is converted to rotational energy, e.g., torque, at a transmission 156. The torque is delivered to vehicle wheels 155. Electric machine 152 may also be operated as a generator to provide electrical power to charge battery 158, for example, during a braking operation.

While electric machine 152 is shown providing rotational energy to the vehicle wheels 155 proximate to a front end 100 of vehicle 105, e.g., at front wheels of the vehicle, via the transmission 156, it will be appreciated that the transmission 156 may be alternatively arranged at rear wheels of vehicle 105, e.g., vehicle wheels 155 proximate to a rear end 102 of the vehicle, and energy from the electric machine 152 transmitted thereto. Alternatively, the transmission 156 may be arranged toward the front end, but transmit mechanical energy from the electric machine 152 to the rear wheels of vehicle 105 via a drive shaft and/or a differential. Furthermore, in other examples, each of the front wheels and the rear wheels may be coupled to individual transmissions, such as when vehicle 105 is configured with all-wheel drive.

In the depicted example, the battery 158 may be installed in a rear region of the vehicle, e.g., between the vehicle wheels 155 and closer to the rear end 102 of the vehicle 105 than the front end 100. In one example, the battery 158 may be positioned below rear passenger seats of the vehicle. In other examples, the battery 158 may be located in a floor of a rear compartment of the vehicle or may be integrated into a vehicle chassis. The battery 158 may be secured within a battery enclosure 168 formed of a rigid material, such as a composite, e.g., a polymer composite. The battery enclosure 168 may entirely enclose the battery 158, providing a barrier between the battery 158 and external components to the battery enclosure 168. The battery enclosure 168 may absorb vibrations from the vehicle that would otherwise be imparted to the battery 158. In order to install the battery 158 within the battery enclosure 168, the enclosure may be comprised of two parts that are assembled around the battery and secured to one another.

The battery assembly (e.g., the battery 158) may be a single battery or may include a plurality of cells or modules electrically coupled to one another. A quantity of the plurality of cells may determine a capacity of the battery 158. The battery 158 may be configured with a high power-to-weight ratio, high specific energy, and high energy density to provide power over long periods of time. Examples of battery types which may be used in vehicle 105 include lithium-ion, lithium polymer, lead-acid, nickel-cadmium, and nick-metal hydride batteries, amongst others. The battery 158 may be a rechargeable battery, such as a battery formed of lithium-ion cells. When configured as a rechargeable battery, the battery 158 may be recharged by regenerative braking operations or an external power source. Battery performance and life may depend on the applied load (and therefore on the charge/discharge rate), as well as operating conditions (such as temperature). The battery 158 may work efficiently over a range of discharge rates (e.g., C/8-2C), within a target range of operating temperatures (typically from 20° C. to 45° C.), and at relatively uniform temperature (e.g., temperature uniformity of less than 5° C.).

Temperature and/or pressure within the battery 158 may rise to a level that is not sustainable for operation of the battery 158 or otherwise results in degradation of the battery 158 as a result of an exothermic reaction and/or thermal event within a battery cell of the battery 158. A rechargeable reaction suppression system with a suppressing agent recharge strategy herein described may be implemented with the battery 158 in order to mitigate temperature rise during such a thermal event within the battery 158, thereby decreasing possibility of degradation to the battery pack and increasing battery pack longevity.

Turning now to FIG. 2, a schematic structural diagram of a battery pack 200 is shown. Battery pack 200 may be at least part of the battery 158 depicted in FIG. 1. Battery pack 200 comprises an enclosure 202, a plurality of battery cells 204, a venting system 220, a monitoring system 240, and an on-board reaction suppression system 230. In some examples, the plurality of battery cells 204 may be configured into multiple battery modules housed within an enclosure. The battery pack 200 is depicted in FIG. 2 in a perspective view with a lid 250 uncoupled from the enclosure 202. In some examples, the lid 250 may be coupled to the enclosure 202 such that the enclosure 202 is sealed off from a surrounding environment with the exception of the venting system 220, as described previously. Sealing off the battery pack 200 from the surrounding environment decreases degradation that may come as a result of exposure to substances in the surrounding environment such as water or dirt.

The plurality of battery cells 204 may be housed within the enclosure 202 of the battery pack 200. The plurality of battery cells 204 may comprise multiple battery cells, such as battery cell 206 and battery cell 208, electrically coupled together. A battery cell is a basic unit of a battery, such as a lithium ion battery, that exerts electric energy by charging and discharging. The energy from the battery cell(s) may then be converted and further used to power components connected to the battery 200, in this case an electric machine of a vehicle.

Battery cells, such as battery cell 206 and battery cell 208 may be prone to exothermic reactions in the event of a fault or a short within the battery cell that cause a rise in the temperature and/or pressure within the enclosure 202. As discussed, rise in temperature and/or pressure within the enclosure 202 may result in degradation of the battery pack 200. The rechargeable reaction suppression system herein described may reduce degradation of the battery pack 200 by mitigating exothermic reactions and thermal events and reducing oxidants within the enclosure that result from exothermic reactions in one or more battery cells.

The on-board reaction suppression system 230 may be coupled to the enclosure 202 of the battery pack 200. The on-board reaction suppression system 230 is depicted in FIG. 2 outside of the enclosure 202 of the battery pack 200. In alternative examples, the on-board reaction suppression system 230 may be positioned within the enclosure 202 of the battery pack 200. The on-board reaction suppression system 230 being positioned outside the enclosure 202 may reduce the space requirements for the battery pack 200. Alternatively, the on-board reaction suppression system 230 being positioned within the enclosure 202 may reduce space requirements outside the battery pack 200.

The on-board reaction suppression system 230 may comprise a first housing 232 that houses a first charge of the suppressing agent. The first housing 232 may be a pressurized canister or other suitable housing. The suppressing agent may be a gas agent, liquid agent, or solid agent (e.g., a powder) configured to suppress thermal events in battery packs. The on-board reaction suppression system 230 may further comprise a manifold 260 and a first valve 236. The manifold 260 may include an outlet pipe 234 that is directly coupled to the first housing 232. The suppressing agent, when dispensed in response to detection of a thermal event within the enclosure 202, may flow out of the first housing 232 and into the manifold 260. The manifold 260 may further comprise an inlet pipe 262 and a plurality of runners 264. The first valve 236 may be positioned somewhere along the outlet pipe 234 such as to separate the first housing 232 from the inlet pipe 262 of the manifold 260. The suppressing agent may flow from the outlet pipe 234, through the first valve 236, into the inlet pipe 262 and then out of the plurality of runners 264 in order to disperse the suppressing agent throughout the enclosure 202. In the depiction shown in FIG. 2, the first valve 236 is positioned in the axis of the enclosure 202, though other positions of the first valve 236 are possible.

The first valve 236 may be in a closed position when the first charge of the suppressing agent is not yet dispensed (e.g., during normal operation of a vehicle such as vehicle 105), and upon actuation, the first valve 236 may open in order to allow the first charge of the suppressing agent to flow from the first housing 232 into the enclosure 202 of the battery pack 200, as will be further described. The first valve 236, and other valves yet to be described, may be actuated mechanically (e.g., spring actuated), pneumatically (e.g., gas pressure actuated), hydraulically (e.g., fluid pressure actuated), or electrically (or electromagnetically via, for example, a solenoid).

In some embodiments, the on-board reaction suppression system 230 further comprises a second valve (not shown). In the first embodiment, the second valve may be positioned to allow flow, when opened, into the first housing 232, as is further described with reference to FIG. 3A. In the second embodiment, the second valve may be positioned to allow flow, when opened, into the manifold 260 (e.g., into the outlet pipe 234), as is described with reference to FIG. 3B. In the third embodiment, the second valve is positioned to allow flow, when opened, directly into the enclosure, bypassing the on-board reaction suppression system 230, as is described with reference to FIG. 3C. As such, the second valve may not be included as part of the on-board reaction suppression system 230 in the third embodiment.

The venting system 220 may be positioned in fluid communication with the enclosure 202. In some examples, the venting system 220 may be a valve configured to equalize pressure between an environment within the enclosure 202 and an environment external to the enclosure 202 during normal operation of the battery pack 200. In other examples, the venting system 220 may be a valve, such as a burst valve, configured to relieve pressure within the enclosure 202 in instances when a thermal event occurs within the enclosure 202. In yet further examples, the venting system 220 may be a valve configured to both equalize pressure during normal operation of the battery pack 200 and relieve pressure during a thermal event.

As described, valves of the reaction suppression system may be actuated to open and/or close in response to sensor data indicating conditions such as pressure or partial pressure of the suppressing agent within enclosures, housings, and/or others. The monitoring system 240 may comprise at least one sensor 242 that senses pressure or temperature within the enclosure 202 of the battery pack 200. In some embodiments, when the sensor 242 of the monitoring system 240 senses a pressure or temperature above a threshold (or temperature and/or pressure rise above a threshold), the sensor may send information to a control system of the on-board reaction suppression system 230 in order to actuate the first valve 236, thereby releasing the first charge of the suppressing agent. Alternatively, in other embodiments, when the sensor 242 of the monitoring system 240 senses a rate of change above a threshold, the sensor may send information to the control system. Thus, when an exothermic reaction occurs in the battery pack 200, combustible gas generated by the reaction of a battery cell (e.g., battery cell 206) in the enclosure 202 may be suppressed by the first charge of the suppressing agent upon discharge from the first housing 232. In this way, the on-board reaction suppression system 230 may act to slow an exothermic reaction and mitigate subsequent reactions.

Referring now to FIGS. 3A-3C, a rechargeable reaction suppression system 300 is shown. FIG. 3A shows the rechargeable reaction suppression system 300 according to the first embodiment. FIG. 3B shows the rechargeable reaction suppression system 300 according to the second embodiment. FIG. 3C shows the rechargeable reaction suppression system 300 according to the third embodiment. In some examples, the rechargeable reaction suppression system 300 may at least in part include the on-board reaction suppression system 230 depicted in FIG. 2. The rechargeable reaction suppression system 300 may include, in some examples, the first housing 232, the first valve 236, a second valve 338, and the outlet pipe 234 of the manifold (not shown) of the on-board reaction suppression system 230, as well as portions of a recharge system 346 that includes a second housing 348 and a piping 344 (e.g., a tubing) that couples the first housing 232 to the second housing 348. Arrow 310 and arrow 312 denote portions of the piping 344 not shown in FIGS. 3A-3C. The piping 344, while depicted as separated, may be a single unit that routes from the on-board reaction suppression system 230 within the vehicle (e.g., vehicle 105 of FIG. 1) (or from the enclosure 202 in the case of the third embodiment) to the second housing 348 located external to the vehicle when the recharge system 346 is connected to the piping 344.

In the first embodiment, as shown in FIG. 3A, a first end 314 of the piping 344 may be fluidly coupled to the first housing 232 while a second end 316 of the piping 344 is fluidly coupled to the second housing 348 when the second housing 348 is coupled to the piping 344 via a connection mechanism 360, as will be further described. The second valve 338, as depicted in FIG. 3A, in the first embodiment, may be integrated to allow flow of suppressing agent between the piping 344 and the first housing 232 such that suppressing agent within the piping 344 may be released into the first housing 232 when the second valve 338 is opened.

Alternatively, in the second embodiment, as shown in FIG. 3B, the first end 314 the piping 344 may be fluidly coupled to the outlet pipe 234 while the second end 316 is fluidly coupled to the second housing 348 when the second housing 348 is coupled to the piping 344 via the connection mechanism 360. In the second embodiment, the second valve 338 may be positioned at some point along the piping 344, including in some examples at the coupling between the piping 344 and the outlet pipe 234, so as to allow flow between the piping 344 and the manifold 260. Thus, the suppressing agent within the piping 344 may be released into the manifold 260 (e.g., into the outlet pipe 234) when the second valve 338 is opened. In this way, the first and second embodiments allow for the on-board reaction suppression system 230 to be recharged and used again to suppress or mitigate reactions and/or thermal events within the enclosure 202.

Alternative to both the first and second embodiments, in the third embodiment, as shown in FIG. 3C, the first end 314 of the piping 344 may be fluidly coupled to the enclosure 202 of the battery pack 200, thus bypassing the on-board reaction suppression system 230 and valves therein. In the third embodiment, the second valve 338 may allow flow between the piping 344 and the enclosure 202 of the battery pack 200 such that suppressing agent within the piping 344 is released directly into the enclosure 202 when the second valve 338 is opened. In this way, the third embodiment allows for deployment of additional charges of suppressing agent directly into the enclosure for faster administration of the suppressing agent compared to the first and second embodiments.

The piping 344, in the first and second embodiments described above and shown in FIGS. 3A and 3B, may route from the on-board reaction suppression system 230 to the second housing 348, thereby creating a path from external to the vehicle to the on-board reaction suppression system 230 through which the second charge of the suppressing agent may be deployed. The second end 316 of the piping 344 may include the connection mechanism 360. The connection mechanism 360 may be accessible at an external access point from external to the vehicle such that the second housing 348, housed elsewhere externally, may be connected to the piping 344 via the connection mechanism 360 in circumstances that demand use of the rechargeable reaction suppression system 300. The connection mechanism 360 may be a valve, a threaded connection, or quick connection that, when the second housing 348 is coupled to the piping 344 via the connection mechanism 360, allows the second charge of the suppressing agent to be deployed from the second housing 348 into the piping 344. As described, the battery pack 200 may be positioned within the vehicle not easily accessible to users. In this way, the piping 344, the connection mechanism 360, and the external access point allow for ease of deployment of the second charge, thereby reducing time spent accessing the battery pack 200 and reducing time between charges. Reduced time between charges may increase mitigation of exothermic reactions.

Further, the rechargeable reaction suppression system 300 includes a control system 362. In some examples the control system 362 may be integrated into the first housing 232. In other examples, the control system 362 may be positioned elsewhere. Control system 362 is shown receiving information from a plurality of sensors 364 and sending control signals to a plurality of actuators 366. As one example, sensors 364 may include sensors such as pressure sensors, partial pressure of suppressing agent sensors (e.g., to detect amount of suppressing agent within the first housing 232 or the piping 344), and/or the like. As another example, the actuators 366 may include mechanical, pneumatic, hydraulic, electric, and/or electromagnetic actuators as previously described.

A strategy for opening and/or closing the first and second valves 236, 338 is needed in order to discharge the first and second charges of the suppressing agent into the enclosure 202 of the battery pack 200 at separate times. Such strategies are described further with respect to FIGS. 4-6. In some examples, the second charge may be injected from the second housing 348 into the piping 344 automatically once the second housing 348 is coupled to the piping 344 via the connection mechanism 360. For example, a user end of the piping 344 where the connection mechanism 360 is positioned may include a valve that opens when the second housing 348 is fully connected to the connection mechanism 360 (e.g., a pneumatic valve) or the connection mechanism 360 may include a puncture valve that opens (e.g., punctures) when the second housing 348 is fully connected. In other examples, the second housing 348 may include a manual actuator that dispenses the second charge of the suppressing agent into the piping 344 when the second housing 348 is coupled to the piping 344.

As noted, the second charge of the suppressing agent may be injected into the piping 344 from the second housing 348 following discharge of the first charge of the suppressing agent into the enclosure 202 from the first housing 232. In some examples, sensor data indicating a (second) rise in temperature and/or pressure within the enclosure may indicate that the second charge is to be injected into the piping 344. In other examples, the second charge may be injected into the piping 344 immediately following discharge of the first charge into the enclosure without waiting for a subsequent rise in temperature and/or pressure within the enclosure. In yet further examples, the second charge may be injected into the piping 344 as determined by an operator (e.g., a user of the vehicle, a first responder, a technician, or the like). In examples in which the second charge is injected in response to sensor data, the second charge may slow a second exothermic reaction and increase mitigation of subsequent thermal events as well as increasing reduction of oxidants in the enclosure. In examples in which the second charge is injected immediately following discharge of the first charge, the second charge may increase reduction of oxidants in the enclosure in order to mitigate subsequent reactions and/or thermal events.

In some embodiments, the first valve 236, the monitoring system 240 (including the sensor 242), and the control system 362 may be connected to the same power supply (e.g., the battery to which it is coupled or another power source) as other components of the vehicle. In other embodiments, the first valve 236, the monitoring system 240 (including the sensor 242), and the control system 362 may be connected to an independent power supply such that the first valve 236 may be actuated even in the event of power loss to the battery.

Turning now to FIG. 4, a flowchart illustrating a method 400 for operating the rechargeable reaction suppression system of a battery pack of an electric vehicle is shown in accordance with the first and/or second embodiments. The rechargeable reaction suppression system herein described may be the rechargeable reaction suppression system of FIGS. 3A-3C which is coupled to the battery pack 200 of FIG. 2. Actions of the method 400 herein described may be responsive to an operating condition of the rechargeable reaction suppression system. The method 400 may be at least partially implemented as executable instructions stored in controller memory in the system of FIGS. 1-3. Additionally, the method 400 may provide the operating sequence shown in FIG. 6.

At 402, the method 400 includes determining operating conditions of the battery pack. The operating conditions may include temperature and/or pressure within the battery pack. A sensor included in a monitoring system of the battery pack may be configured to sense pressure and/or temperature. Elevated pressure and/or temperature may indicate that a reaction or thermal event is occurring in one or more battery cells of the battery pack.

At 404, the method 400 includes judging whether a thermal event is detected. A thermal event may be detected based on sensor data regarding pressure and/or temperature within an enclosure of the battery pack (e.g., enclosure 202 of FIGS. 2-3). If pressure and/or temperature are detected above a preset threshold value or a rise in pressure and/or temperature is detected above a preset threshold value, a thermal event may be detected. If a thermal event is detected (YES), method 400 proceeds to 406. If a thermal event is not detected (NO), method 400 returns to 402 to continuing determining operating conditions of the battery pack.

At 406, in response to the thermal event being detected, method 400 includes deploying a first charge of a suppressing agent into the enclosure of the battery pack. The first charge of the suppressing agent may be housed within a first housing (e.g., first housing 232 of FIGS. 2 and 3) of an on-board reaction suppression system (on-board reaction suppression system 230 of FIG. 2). The first housing may be in fluid communication with the enclosure of the battery pack via an outlet pipe (e.g., outlet pipe 234) of a manifold and a first valve (e.g., first valve 236) in embodiments in which the first housing is located external to the enclosure. The first valve may be actuated to open in response to detection of the thermal event. When the first valve opens, the first charge of the suppressing agent that is housed in the first housing may be deployed to within the enclosure of the battery pack via the manifold (e.g., manifold 260 of FIG. 2). The suppressing agent may be configured to slow the reaction and mitigate subsequent reactions.

At 408, method 400 includes recharging the rechargeable reaction suppression system with a second charge of the suppressing agent. In some examples, recharging the rechargeable reaction suppression system may occur in response to sensor data signaling that the second charge of the suppressing agent is indicated. In other examples, recharging the rechargeable reaction suppression system may occur automatically in response to coupling of a second housing to a piping, as previously described. The second charge of the suppressing agent may be housed external to the electric vehicle in the second housing (e.g., second housing 348). As described with reference to FIGS. 3A-3C, the second housing of the suppressing agent may be coupled to the piping via a connection mechanism. As previously described, the piping may route from the on-board reaction suppression system to an external access point that is accessible from external to the electric vehicle. Deployment of the second charge of the suppressing agent from the second housing to the on-board reaction suppression system may recharge the rechargeable reaction suppression system. As described with reference to FIGS. 3A-3C, the piping into which the second charge of the suppressing agent is deployed may be in fluid communication with the first housing, the outlet pipe of the manifold, or directly with the enclosure of the battery pack.

As is described above, recharging the rechargeable reaction suppression system may comprise refilling the first housing with the second charge of the suppressing agent in the first embodiment or holding the second charge of the suppressing agent in the piping in the second and third embodiments.

At 410, the method 400 includes deploying the second charge of the suppressing agent into the enclosure of the battery pack. After recharging the rechargeable reaction suppression system with the second charge of the suppressing agent, the second charge of the suppressing agent is deployed into the enclosure of the battery pack. In some examples, deploying the second charge may occur in response to sensor data, such as sensor data indicating a second rise in temperature and/or pressure within the enclosure or sensor data indicating a rise in pressure or partial pressure of the suppressing agent within the first housing or outlet pipe. In varying embodiments, the second charge of the suppressing agent may be deployed: (1) from the first housing when recharging entails refilling the first housing with the second charge; (2) from the outlet pipe that couples the first housing to the enclosure when the piping that routes from the second housing to the reaction suppression system couples to the outlet pipe; or (3) directly from the piping into the enclosure of the battery pack when the piping bypasses the first housing and outlet pipe. In any of these varying embodiments, the second charge of the suppressing agent is deployed into the enclosure of the battery pack following deployment of the first charge and recharge of the system. A plurality of valves is included in the rechargeable reaction suppression system, as described with reference to FIGS. 2-3 that are actuated to open or close in response to varying conditions. A method for operation of valves in the system for the first embodiment herein described is referenced in greater detail with respect to FIG. 5.

Referring now to FIG. 5, a flowchart illustrating a method 500 for operation of a rechargeable reaction suppression system for a battery pack of a vehicle according to the first embodiment of the present disclosure is shown. The rechargeable reaction suppression system herein described may be the rechargeable reaction suppression system 300 of FIGS. 3A-3C which is coupled to the battery pack 200 of FIG. 2. The rechargeable reaction suppression system described with reference to method 400 of FIG. 4 may be the same system as described herein with reference to method 500. Actuation (e.g., adjusting a configuration) of each of the valves herein described may be responsive to an operating condition of the rechargeable reaction suppression system as detected by a plurality of sensors located within an enclosure of the battery pack and/or included in the rechargeable reaction suppression system. The method 500 may be at least partially implemented as executable instructions stored in controller memory in the system of FIGS. 1-3. Additionally, the method 500 may provide the operating sequence shown in FIG. 6. Method 500 describes a method of operation of the rechargeable reaction suppression system according to the first embodiment in which a first housing of a suppressing agent is refilled with a second charge and a piping between the first housing and a second housing that houses the second charge provides fluid communication between the first housing and the second housing. It should be understood that similar methods for valve actuation may be implemented for the second and third embodiments of the present disclosure.

At 502, method 500 includes determining operating conditions of the battery pack. The operating conditions may include temperature and/or pressure within the enclosure. A sensor included in a monitoring system of the battery pack may be configured to sense pressure and/or temperature. Elevated pressure and/or temperature may indicate that a reaction or thermal event is occurring in one or more battery cells of the battery pack.

At 504, the method 500 includes judging whether a thermal event is detected. A thermal event may be detected based on sensor data regarding pressure and/or temperature within the enclosure of the battery pack (e.g., enclosure 202 of FIGS. 2-3). If pressure and/or temperature are detected above a preset threshold value, a thermal event may be detected. If a thermal event is detected (YES), method 500 proceeds to 506. If a thermal event is not detected (NO), method 500 returns to 502 to continue determining operating conditions of the battery pack.

At 506, the method 500 includes actuating a first valve to open. The first valve may be in fluid communication with the enclosure of the battery pack and with a manifold including an outlet pipe (e.g., outlet pipe 234). The first valve, prior to actuation, may be normally closed and as such a first charge of the suppressing agent may be housed and pressurized within the first housing. The outlet pipe may be in fluid communication with the first housing of a suppressing agent such that when the first valve opens, the first charge of the suppressing agent housed within the first housing is discharged into the enclosure of the battery pack via a manifold (e.g., manifold 260 of FIG. 2). The manifold may be in fluid communication with the first valve and may comprise the outlet pipe, an inlet pip and a plurality of runners configured to disperse the suppressing agent throughout the enclosure.

At 508, the method 500 includes judging whether the first charge of the suppressing agent has been deployed into the enclosure of the battery pack. One or more sensors of a control system (e.g., sensors 364 of control system 362 located within the first housing of the suppressing agent may sense overall pressure, partial pressure of the suppressing agent, or the like in order to determine whether the first charge of the suppressing agent has been fully discharged out of the first housing. If pressure, partial pressure of the suppressing agent, or other condition within the first housing as sensed by the sensors drops below a preset threshold value, the first charge of the suppressing agent may be determined as deployed (YES) and the method 500 proceeds to 512. If pressure, partial pressure of the suppressing agent, or other condition within the first housing as sensed by the sensors has not dropped below the preset threshold (NO), the method 500 proceeds to 510.

At 510, the method 500 includes maintaining the open position of the first valve. Maintaining the open position of the first valve may allow for the first charge of the suppressing agent to continue to flow from the first housing into the enclosure. Method 500 then returns to 508 to judge whether the first charge has been fully deployed from the first housing.

At 512, the method 500 includes actuating the first valve to close in response to sensor data indicating that the first charge of the suppressing agent has been deployed fully or nearly fully from the first housing. Closing of the first valve halts flow of gases or other substances between the enclosure of the battery pack and the first housing and as such no suppressing agent may discharge from or enter into the outlet pipe or the first housing when the first valve is closed.

At 514, the method 500 judges whether a second charge of the suppressing agent has been injected into the piping. The second charge of the suppressing agent may be housed in the second housing until sensor data signals that the second charge is to be deployed to recharge the rechargeable reaction suppression system. The first charge of the suppressing agent is deployed into the enclosure of the battery pack in response to detection of a thermal event prior to the second charge being deployed into the piping. The second charge may be discharged from the second housing and injected into the piping by a user (e.g., a driver of the vehicle, a first responder, a technician, or the like) in response to an indication that the first charge has been deployed, in some examples. The piping may route from the second housing to the first housing, according to the first embodiment. Discharge of the second charge from the second housing into the piping may be realized manually (e.g., via a manual valve) or automatically when the second housing is coupled to the connection mechanism, as is described with reference to FIGS. 3A-3C.

The sensors of the control system may sense overall pressure, partial pressure of the suppressing agent, or the like within the piping so as to determine whether the second charge of the suppressing agent has been injected from the second housing into the piping. If the sensors detect pressure, partial pressure of the suppressing agent, or other defined condition above a preset threshold, the second charge is judged to be injected fully or nearly fully (YES) and method 500 proceeds to 518. If the sensors do not detect pressure, partial pressure of the suppressing agent, or other defined condition above the preset threshold (NO), method 500 proceeds to 516.

At 516, the method 500 includes maintaining closed positions of the first valve and a second valve. In the closed position, the first valve prohibits flow between the enclosure of the battery pack and the first housing. In the closed position, the second valve prohibits flow between the first housing and a piping (e.g., piping 344 of FIGS. 3A-3C). The piping routes to an external access point that includes a connection mechanism (e.g., connection mechanism 360) configured to couple the piping to the second housing which is located external to the electric vehicle. The second housing houses the second charge of the suppressing agent.

At 518, the method 500 judges whether a second charge of the suppressing agent is indicated. In some examples, determination that the second charge of the suppressing agent is indicated may be based on sensor data from within the enclosure. A monitoring system (e.g., monitoring system 240) included in the enclosure of the battery pack may sense temperature and/or pressure rise, as described previously with respect to 504. If pressure and/or temperature rises above a preset threshold, signals from the monitoring system may indicate that the second charge of the suppressing agent is demanded. The preset threshold for the second charge of the suppressing agent may be different or the same as the preset threshold that indicated the initial thermal event at 504. If sensor data signals that the second charge is indicated (YES), method 500 proceeds to 522. If sensor data does not signal that the second charge is indicated (NO), method 500 proceeds to 520.

At 520, the method 500 includes maintaining closed positions of the first and second valves. The first valve, as previously described, may be normally closed and when opened allows for flow between the first housing and the enclosure of the battery pack. The second valve (e.g., second valve 338 of FIGS. 3A-3C), according to the first embodiment described herein, may be normally closed and when opened allows for flow between the piping and the first housing such that suppressing agent injected into the piping may flow into the first housing when the second valve is opened. When closed, flow is not permitted between the piping and the first housing. Similarly, as noted, when the first valve is closed, flow is not permitted between the first housing and the enclosure. Method 500 then returns to 518 to judge whether the second charge of the suppressing agent has been injected fully into the piping.

At 522, method 500 includes actuating the second valve to open in response to sensor data indicating that the second charge of the suppressing agent has been injected fully or nearly fully into the piping and that a second charge is indicated. Once opened, the second valve permits flow from the piping into the first housing, thereby recharging the rechargeable reaction suppression system by refilling the first housing with the second charge of the suppressing agent, according to the embodiment described herein.

At 524, the method 500 judges whether the second charge of the suppressing agent has been deployed into the first housing. As described, following actuation of the second valve, the second charge of the suppressing agent may flow from the piping into the first housing. Sensors of the control system may detect pressure, partial pressure, or the like within the first housing in order to determine whether the second charge has been fully or nearly fully deployed from the piping into the first housing. If sensor data indicates that pressure, partial pressure of the suppressing agent, or other defined parameter is above a preset threshold for the first housing (YES), the method 500 proceeds to 528. If sensor data indicates that pressure, partial pressure of the suppressing agent, or other defined parameter is not above the preset threshold for the first housing (NO), the method 500 proceeds to 526.

At 526, the method 500 includes maintaining the open position of the second valve and the closed position of the first valve. Maintaining the open position of the second valve may allow for continued flow of suppressing agent from the piping into the first housing in order to allow fully recharging of the rechargeable reaction suppression system.

At 528, the method 500 includes actuating the second valve to close and actuating the first valve to open, thereby deploying the second charge from the first housing into the enclosure of the battery pack. Closing the second valve seals off the first housing from the piping and opening the first valve permits flow of the second charge of the suppressing agent from the first housing into the enclosure of the battery pack via the manifold. The method 500 may then end. In some embodiments, additional second charges from additional external housings may be deployed to repeat recharge of the system by way of repeating 514 through 528 for each additional charge. In such embodiments, the first valve may be actuated to close prior to returning to 514.

In some examples, the second valve may be actuated to open in response to indication that the second charge is fully deployed within the piping rather than in response to indication that a second charge is indicated, thereby refilling the first housing prior to an indication that the second charge is indicated. In such cases, when the second charge is indicated based on sensor data of temperature and/or pressure within the enclosure, the first valve may be actuated to open, similar to deployment of the first charge.

In the second embodiment of the disclosure, the second valve may be positioned so as to allow flow, when opened, between the piping and the manifold of the on-board reaction suppression system. When the second valve is opened, similar to at 522, the second charge of the suppressing agent may be discharged from the piping into the manifold. Method 500 may judge whether the second charge has been fully deployed into the outlet pipe based on sensor data similar to as described at 524. Actuation of the first and second valves may then follow as described at 528 in response to the second charge being determined to be fully deployed into the outlet pipe.

In the third embodiment of the disclosure, the second valve may be positioned so as to allow flow, when opened, between the piping and the enclosure. When the second valve is opened, similar to at 522, the second charge of the suppressing agent may be discharged into the enclosure and the method may then end.

Turning now to FIG. 6, a use-case operating sequence for a rechargeable reaction suppression system of a battery pack of an electric vehicle is shown in timing diagram 600. The operating sequence herein described details conditions in various components of the rechargeable reaction suppression system during a scenario in which the rechargeable reaction suppression system deploys a first charge, recharges, and deploys a second charge. The scenario herein described is in accordance with the first embodiment of the present disclosure in which recharging the rechargeable reaction suppression system comprises refilling a first housing with the second charge following the first charge being deployed into an enclosure of the battery pack. Other operating sequences may occur for the second and third embodiments as previously discussed. The operating sequence of FIG. 6 may be provided via the systems of FIGS. 1-3A in cooperation with the methods of FIGS. 4-5.

The vertical lines at times t0-t5 represent times of interest during the operating sequence. The plots are time aligned. In each graph, time is indicated on the abscissa and increases from left to right. The ordinate for plot 602 indicates an operational state of a first valve (e.g., open or closed). Open indicates that the valve is allowing flow between components that it fluidically couples (e.g., the first housing and the enclosure of the battery pack in the case of the first valve herein described) and closed indicates that the valve is not allowing flow. The ordinate for plot 604 indicates an operational state of a second valve (e.g., open or closed). The ordinate for plot 606 indicates pressure in the first housing, where pressure increases along the ordinate from zero towards the arrow. The ordinate for plot 608 indicates pressure in a second housing, where pressure increases along the ordinate from zero towards the arrow. The ordinate for plot 610 indicates pressure in a piping, where pressure increases along the ordinate from zero towards the arrow. The ordinate for plot 612 indicates temperature in the enclosure, where temperature increases along the ordinate from zero towards the arrow. The ordinate for plot 614 indicates pressure in the enclosure, where pressure increases along the ordinate from zero towards the arrow.

At time t0, the battery pack of the electric vehicle is operating under normal conditions, wherein no thermal event has occurred and a venting system included therein is equalizing pressure between the enclosure and an external environment. At time t0, the first and second valves are closed, pressure in the first and second housings is high, indicating that the first and second charge of the suppressing agent is housed within each housing, respectively, and is pressurized, pressure in the piping is low, and temperature and pressure within the enclosure are low.

Between time t0 and time t1, temperature and pressure within the enclosure rise. At time t1, temperature in the enclosure rises above a first threshold 620 and pressure in the enclosure rises above a first threshold 624. Sensors included within the enclosure sense pressure and/or temperature and send signals to actuators in order to actuate the first and/or second valves and/or to signal that the second charge of the suppressing agent is indicated. In response to temperature and pressure rising between t1 and t0, sensors may send signals to actuators to actuate the first valve to open. At time t1, in response to signal data indicating that the pressure and/or temperature within the enclosure has risen above the respective threshold, the first valve transitions from closed to open.

Between times t1 and t2, the pressure in the first housing decreases as the first charge of the suppressing agent is deployed from the first housing into the enclosure of the battery pack. In some examples, the first charge may be deployed into a manifold that disperses the suppressing agent throughout the enclosure via a plurality of runners. Also between times t1 and t2, the pressure and temperature in the enclosure decrease as the first charge of the suppressing agent takes effect within the enclosure.

At time t2, the first valve transitions from open to closed in response to the first charge of the suppressing agent being fully deployed into the enclosure, determined by sensor data indicating that the pressure or partial pressure of the suppressing agent within the first housing has dropped below a threshold 628.

Between times t2 and t3, temperature and pressure within the enclosure increases. At time t3, temperature rises above a second threshold 622 and pressure rises above a second threshold 626. In some embodiments, the second thresholds 622, 626 may be different than the first thresholds 620, 624. In other embodiments, the second thresholds 622, 626 may be the same as the first thresholds 620, 624. Sensors detecting that the temperature and/or pressure in the enclosure rising above the second threshold may indicate that the second charge of the suppressing agent is to be deployed from the second housing in order to recharge the rechargeable reaction suppression system and/or that the second charge is to be deployed into the enclosure.

Between times t3 and t4, pressure in the second housing decreases while pressure in the piping increases as a result of the second charge of the suppressant being deployed from the second housing into the piping. The first and second valves remain closed while the second charge is deployed into the piping and the temperature and pressure within the enclosure are unaffected by the second charge being deployed into the second housing. At time t4, the second valve transitions from closed to open in response to the pressure in the piping rising above a threshold 618.

Between times t4 and t5, pressure in the first housing increases as pressure in the piping decreases as a result of the second charge of the suppressing agent flowing from the piping into the first housing after the second vale is opened. The first valve remains closed and temperature and pressure within the enclosure are unaffected by the opening of the second valve. The pressure within the first housing may rise to or above a threshold 616. The pressure in the first housing prior to discharge of the first charge (e.g., at time t0) may be above the threshold 616 in some examples. At time t5, the second valve transitions from open to closed while the first valve transitions from closed to open in response to the pressure in the first housing rising to or above the threshold 616.

After time t5, pressure in the first housing decreases and pressure and temperature within the enclosure decrease, all as a result of the second charge of the suppressing agent being deployed into the enclosure through the first valve.

A technical effect of the rechargeable suppression system as herein described is that reactions within a battery pack may be slowed and subsequent reactions and/or thermal events may be mitigated by way of administered a second charge of suppressing agent to cells within the enclosure. Mitigation of thermal events within the enclosure may reduce degradation to battery cells and to the battery pack, thereby increasing longevity and decreasing repair costs.

Further, by way of the connection mechanism and the external access point, ease of use of the rechargeable reaction suppression system is increased. The external access point allows for an operator to easily access a route to the on-board reaction suppression system, thereby decreasing time spent accessing the on-board reaction suppression system and decreasing time between indication of need for the second charge and injection of the second charge out of the second housing.

In another representation, a method of operation of the rechargeable reaction suppression system of a battery pack of a vehicle includes discharging a first charge of a suppressing agent from an on-board reaction suppression system into an enclosure of the battery pack in response to sensor data indicating detection of a thermal event within the enclosure, and visually indicating that the first charge has been discharged. The visual indication may indicate a need for recharging. Further, the method may include receiving a second charge of suppressing agent, storing the second charge, and discharging the second charge in response to a detected event by the battery pack controller. The release discharge of the second charge may be via the same distribution system of the on-board reaction suppression system as with the first charge, or may be different. The discharge of the second charge may further be based on the sensor data, or different sensor data, such as an elapsed time. Further, as described herein, valve control and adjustment may be used to provide the discharge of the first charge, receiving of the second charge, and/or discharge of the second charge, and/or subcombinations thereof.

The disclosure also provides support for a method of operation of a rechargeable reaction suppression system of a battery pack of a vehicle, comprising: discharging a first charge of a suppressing agent from a first housing of an on-board reaction suppression system into an enclosure of the battery pack via a first valve in response to sensor data indicating detection of a thermal event within the enclosure, adjusting a configuration of a second valve to enable reception of a second charge of the suppressing agent by the on-board reaction suppression system, and receiving the second charge from a second housing via the second valve in order to recharge the on-board reaction suppression system. In a first example of the method,: the first valve is normally closed and when opened, allows flow between the first housing and the enclosure via an outlet pipe of a manifold, and the second valve is normally closed and when opened, allows flow between a piping and one of the first housing and the manifold. In a second example of the method, optionally including the first example, adjusting the configuration of the second valve comprises actuating the second valve to open in response to sensor data. In a third example of the method, optionally including one or both of the first and second examples, the method further comprises: discharging the second charge of the suppressing agent from the on-board reaction suppression system into the enclosure. In a fourth example of the method, optionally including one or more or each of the first through third examples, the method further comprises: actuating the first valve to open in response to sensor data indicating detection of the thermal event. In a fifth example of the method, optionally including one or more or each of the first through fourth examples, the method further comprises: actuating the first valve to close in response to sensor data indicating the first charge has been fully discharged into the enclosure. In a sixth example of the method, optionally including one or more or each of the first through fifth examples, the second charge of the suppressing agent is injected into the piping, the piping routing from an external access point to the on-board reaction suppression system. In a seventh example of the method, optionally including one or more or each of the first through sixth examples, the method further comprises: actuating the second valve to open in response to sensor data indicating that the second charge is fully or nearly fully injected into the piping and temperature and/or pressure within the enclosure is above a preset threshold. In a eighth example of the method, optionally including one or more or each of the first through seventh examples, the method further comprises: actuating the first valve to open and the second valve to close in response to sensor data indicating the second charge is fully or nearly fully discharged into one of the first housing and the outlet pipe.

The disclosure also provides support for a battery system for a vehicle, comprising, a battery pack including a plurality of battery cells housed within an enclosure, a rechargeable reaction suppression system connected to the enclosure of the battery pack comprising an on-board reaction suppression system and a piping of a recharge system that routes from an external access point to the on-board reaction suppression system, and a control system including one or more sensors and one or more actuators, the one or more sensors being configured to sense temperature, pressure, and/or partial pressure of a suppressing agent within the enclosure, the on-board reaction suppression system, and/or the piping of the recharge system, wherein: the rechargeable reaction suppression system further comprises a plurality of valves that are actuated by the one or more actuators of the control system. In a first example of the system,: the on-board reaction suppression system comprises a first housing of the suppressing agent, an outlet pipe of a manifold, a first valve of the plurality of valves, and a second valve of the plurality of valves, the piping of the recharge system couples a second housing located external to the vehicle to one of the first housing and the manifold, and the piping couples to the second housing at the external access point via a connection mechanism. In a second example of the system, optionally including the first example, the system further comprises: a first charge of the suppressing agent housed within and deployed from the first housing, and a second charge of the suppressing agent received by the on-board reaction suppression system during recharge of the rechargeable reaction suppression system. In a third example of the system, optionally including one or both of the first and second examples, coordinated actuation of the plurality of valves in response to data from the one or more sensors discharges the first charge from the first housing into the enclosure, recharges the rechargeable reaction suppression system with the second charge, and discharges the second charge into the enclosure. In a fourth example of the system, optionally including one or more or each of the first through third examples, the on-board reaction suppression system is positioned within the enclosure or external and directly coupled to the enclosure and the second housing of the recharge system is positioned external to the vehicle.

The disclosure also provides support for a reaction suppression system for a battery pack of a vehicle, comprising: an on-board reaction suppression system comprising a first housing of a suppressing agent, a manifold, and a first valve, a piping of a recharge system routing from an enclosure of the battery pack to an external access point, the piping coupling the enclosure to a second housing located external to the vehicle, a first charge of the suppressing agent housed within and discharged into the enclosure from the first housing via the first valve, and a second charge of the suppressing agent housed within the second housing and discharged into the enclosure from the second housing via the piping and a second valve. In a first example of the system, the second housing is coupled to the piping via a connection mechanism at the external access point. In a second example of the system, optionally including the first example, the on-board reaction suppression system is positioned either within the enclosure of the battery pack or external and directly coupled to the enclosure of the battery pack. In a third example of the system, optionally including one or both of the first and second examples, the system further comprises: a plurality of sensors configured to sense temperature, pressure, and/or partial pressure of the suppressing agent within the enclosure of the battery pack and/or the piping. In a fourth example of the system, optionally including one or more or each of the first through third examples, the second valve is positioned within the piping at an inlet to the enclosure, the second valve opening in response to sensor data in order to release the second charge of the suppressing agent into the enclosure via the second valve. In a fifth example of the system, optionally including one or more or each of the first through fourth examples, the second valve opens in response to indication of temperature and/or pressure rise within the enclosure as sensed by the plurality of sensors.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of operation of a rechargeable reaction suppression system of a battery pack of a vehicle, comprising:
discharging a first charge of a suppressing agent from a first housing of an on-board reaction suppression system into an enclosure of the battery pack via a first valve in response to sensor data indicating detection of a thermal event within the enclosure;
adjusting a configuration of a second valve to enable reception of a second charge of the suppressing agent by the on-board reaction suppression system; and
receiving the second charge from a second housing via the second valve in order to recharge the on-board reaction suppression system.

2. The method of claim 1, wherein:
the first valve is normally closed and when opened, allows flow between the first housing and the enclosure via an outlet pipe of a manifold; and
the second valve is normally closed and when opened, allows flow between a piping and one of the first housing and the manifold.

3. The method of claim 1, wherein adjusting the configuration of the second valve comprises actuating the second valve to open in response to sensor data.

4. The method of claim 1, further comprising discharging the second charge of the suppressing agent from the on-board reaction suppression system into the enclosure.

5. The method of claim 1, further comprising actuating the first valve to open in response to sensor data indicating detection of the thermal event.

6. The method of claim 1, further comprising actuating the first valve to close in response to sensor data indicating the first charge has been fully discharged into the enclosure.

7. The method of claim 2, wherein the second charge of the suppressing agent is injected into the piping, the piping routing from an external access point to the on-board reaction suppression system.

8. The method of claim 2, further comprising actuating the second valve to open in response to sensor data indicating that the second charge is fully or nearly fully injected into the piping and temperature and/or pressure within the enclosure is above a preset threshold.

9. The method of claim 2, further comprising actuating the first valve to open and the second valve to close in response to sensor data indicating the second charge is fully or nearly fully discharged into one of the first housing and the outlet pipe.

10. A battery system for a vehicle, comprising;
a battery pack including a plurality of battery cells housed within an enclosure;
a rechargeable reaction suppression system connected to the enclosure of the battery pack comprising an on-board reaction suppression system and a recharge system including a piping that routes from an external access point to the on-board reaction suppression system; and
a control system including one or more sensors and one or more actuators, the one or more sensors being configured to sense temperature, pressure, and/or partial pressure of a suppressing agent within the enclosure, the on-board reaction suppression system, and/or the piping of the recharge system, wherein:
the rechargeable reaction suppression system further comprises a plurality of valves that are actuated by the one or more actuators of the control system.

11. The battery system of claim 10, wherein:
the on-board reaction suppression system comprises a first housing of the suppressing agent, an outlet pipe of a manifold, a first valve of the plurality of valves, and a second valve of the plurality of valves;
the piping of the recharge system couples a second housing located external to the vehicle to one of the first housing and the manifold; and
the piping couples to the second housing at the external access point via a connection mechanism.

12. The battery system of claim 11, further comprising:
a first charge of the suppressing agent housed within and deployed from the first housing; and
a second charge of the suppressing agent received by the on-board reaction suppression system during recharge of the rechargeable reaction suppression system.

13. The battery system of claim 12, wherein coordinated actuation of the plurality of valves in response to data from the one or more sensors discharges the first charge from the first housing into the enclosure, recharges the rechargeable reaction suppression system with the second charge, and discharges the second charge into the enclosure.

14. The battery system of claim 11, wherein the on-board reaction suppression system is positioned within the enclosure or external and directly coupled to the enclosure and the second housing of the recharge system is positioned external to the vehicle.

15. A reaction suppression system for a battery pack of a vehicle, comprising:
an on-board reaction suppression system comprising a first housing of a suppressing agent, a manifold, and a first valve;
a recharge system including a piping routing from an enclosure of the battery pack to an external access point, the piping coupling the enclosure to a second housing located external to the vehicle;
a first charge of the suppressing agent housed within and discharged into the enclosure from the first housing via the first valve; and
a second charge of the suppressing agent housed within the second housing and discharged into the enclosure from the second housing via the piping and a second valve.

16. The reaction suppression system of claim 15, wherein the second housing is coupled to the piping via a connection mechanism at the external access point.

17. The reaction suppression system of claim 15, wherein the on-board reaction suppression system is positioned either within the enclosure of the battery pack or external and directly coupled to the enclosure of the battery pack.

18. The reaction suppression system of claim 15, further comprising a plurality of sensors configured to sense temperature, pressure, and/or partial pressure of the suppressing agent within the enclosure of the battery pack and/or the piping.

19. The reaction suppression system of claim 15, wherein the second valve is positioned within the piping at an inlet to the enclosure, the second valve opening in response to sensor data in order to release the second charge of the suppressing agent into the enclosure via the second valve.

20. The reaction suppression system of claim 18, wherein the second valve opens in response to indication of temperature and/or pressure rise within the enclosure as sensed by the plurality of sensors.
